(19) United States
(12) Patent Application Publication
(10) Pub. No.: US 2017/0109837 A1
(43) Pub. Date: Apr. 20, 2017

(54) KNOW YOUR CUSTOMER ALERT SYSTEMS AND METHODS

(71) Applicant: Early Warning Services, LLC, Scottsdale, AZ (US)

(72) Inventors: Ravi Loganathan, Charlotte, NC (US); Ronald Scott Alcorn, Austin, TX (US); Jie He, Naperville, IL (US); Steve Fleming, Austin, TX (US); Jeff Parent, Tempe, AZ (US)

(73) Assignee: Early Warning Services, LLC, Scottsdale, AZ (US)

(21) Appl. No.: 14/949,416

(22) Filed: Nov. 23, 2015

Related U.S. Application Data
(60) Provisional application No. 62/242,790, filed on Oct. 16, 2015.
(60) Provisional application No. 62/243,990, filed on Oct. 20, 2015.

(51) Int. Cl. G06Q 40/00

(52) U.S. Cl. CPC G06Q 40/128

(57) ABSTRACT

Transaction data is analyzed according to one or more transaction rules to identify accounts that are suspected of being used for activity such as money laundering. The methods may be performed on an inquiry basis for ad hoc investigation of transaction activity relating to one or more particular account owners or other entities, or may be performed on an ongoing basis for monitoring transaction activity of one or more account owners or other entities for suspicious activity.

This application claims the benefit of provisional U.S. Patent Application No. 62/242,790 filed Oct. 16, 2015, and titled “Method for Detecting and Tracking Correspondent Items from U.S. Subsidiaries of International Banks” and provisional U.S. Patent Application No. 62/243,990 filed Oct. 20, 2015, and titled “Method to Detect Cash Equivalent Deposit Structuring and Funnel Account Behavior”, the entire disclosures of which are hereby incorporated by reference herein for all purposes.

### BACKGROUND OF THE INVENTION

Financial institutions are required by regulation to take various actions designed to detect and discourage money laundering. For example, financial institutions are required to perform a level of due diligence to verify the identities of their customers (known as a “Know Your Customer” program), to report large cash currency transactions and other suspicious activity, and to take other actions. In some instances where illicit activity is suspected, financial institutions are permitted to share confidential information among institutions.

Financial institutions collect large amounts of information on accounts used for transactions. Such information may be used for various purposes, for example to authenticate persons conducting transactions, and to detect the occurrence of transactions that are suspected of being fraudulent. Information may be collected from many sources and in many different forms, and as such it may be difficult to understand how different pieces of information may relate to a specific person or transaction.

### BRIEF SUMMARY OF THE INVENTION

According to one aspect, a method for identifying suspicious account activity comprises maintaining one or more computerized databases holding records of financial transactions and other information. The information includes information about financial transactions involving a number of accounts and ownership records of the number of accounts. The method further comprises receiving an indication of the identity of a particular entity for investigation. From the account ownership records, one or more accounts associated with the particular entity are identified. The method further comprises analyzing transaction records of the accounts associated with the particular entity according to one or more transaction rules. The analysis according to at least one of the transaction rules results in a determination that suspicious activity has been detected with respect to one or more particular accounts. The method further comprises querying for negative contributed information relating to the identified entity, and querying for public event information relating to the identified entity. A report is produced naming the identified entity, and including at least the fact of the detection of suspicious activity in the one or more particular accounts.

### BRIEF DESCRIPTION OF THE DRAWINGS

FIG. 1 illustrates a system in accordance with embodiments of the invention.

FIG. 2 illustrates a flow chart of a method in accordance with embodiments of the invention.

FIG. 3 illustrates a flow chart of a method in accordance with embodiments of the invention.

FIG. 4 illustrates a flow chart of a method in accordance with embodiments of the invention for identifying records of an account for further investigation.

FIG. 5 illustrates a flow chart of a method in accordance with embodiments of the invention, for analysis of deposits identified in the method of FIG. 4.

FIG. 6 illustrates a flow chart of a method in accordance with other embodiments of the invention, for analysis of deposits identified in the method of FIG. 4.

FIG. 7 illustrates a flow chart of a method in accordance with other embodiments of the invention, for analysis of deposits identified in the method of FIG. 4.

FIG. 8 illustrates a flow chart of a method in accordance with embodiments of the invention, for analyzing transaction data to identify one or more suspect entities.

FIG. 9 illustrates a block diagram of an exemplary computer system upon which embodiments of the present invention may be implemented.

### DETAILED DESCRIPTION OF THE INVENTION

Embodiments of the invention provide methods and systems for analyzing information about financial transactions involving certain kinds of accounts. Such techniques may be helpful in uncovering fraud such as money laundering, or as part of a Know Your Customer program.

Money laundering is the process of concealing the existence, source, or use of funds, to make the funds appear legitimately obtained or used. While there are many money laundering schemes, some involve such techniques as:

structuring—making deposits in a pattern intended to avoid suspicion, for example breaking up a large deposit into a series of smaller deposits each of which is below a threshold amount for which cash transactions must be reported to authorities;

funnel accounts—a funnel account is defined by the U.S. Treasury Department as an individual or business account in one geographic area that receives multiple cash deposits, often in amounts below the cash reporting threshold, and from which the funds are withdrawn in a different geographic area with little time elapsing between the deposits and withdrawals; and

trade-based money laundering—masking the transfer of money by making it appear to be part of legitimate commercial trade, for example by paying much more or much less for goods than their actual value.

In particular, some embodiments of the invention provide methods and systems for analyzing transaction information and other information to uncover suspected illicit activity such as money laundering, and for reporting the results of the analysis with supplemental information. The methods may be performed on an inquiry basis for ad hoc investigation of transaction activity relating to one or more particular account owners, or may be performed on an ongoing basis for monitoring transaction activity of for evidence of suspicious activity.

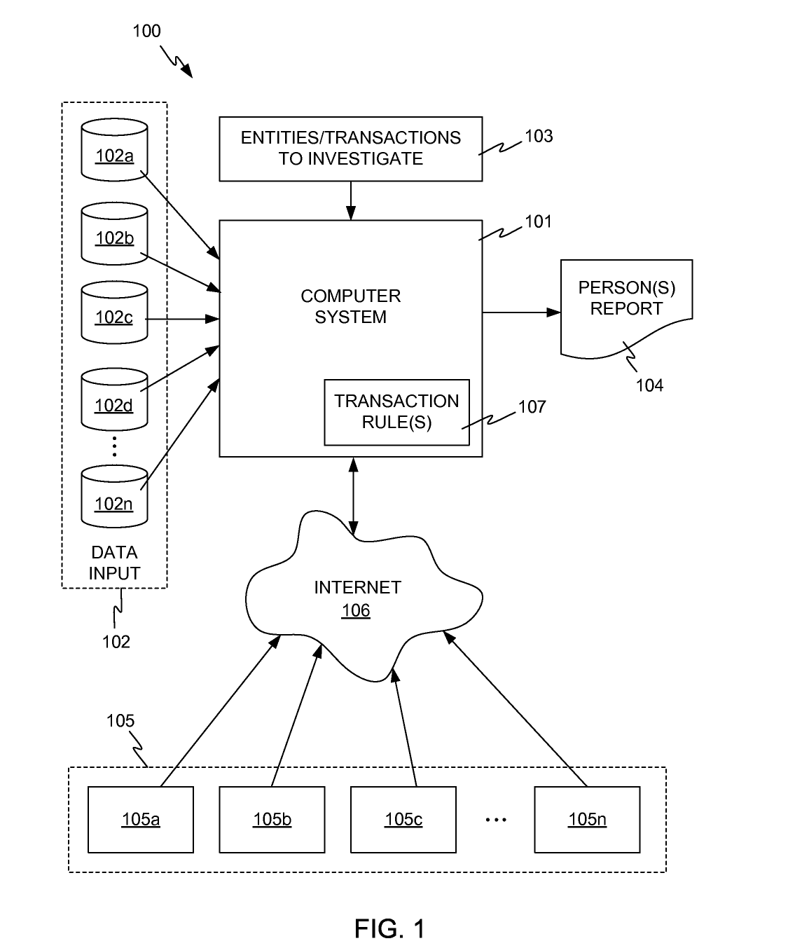

FIG. 1 illustrates a system 100 in accordance with embodiments of the invention. A computer system 101 is coupled to one or more databases 102. Databases 102 may be organized in any suitable manner. For example, all of the stored information may be considered to be one large database 102, or the information may be considered to be organized into a number of specialized databases. Databases 102 may hold a variety of information. For example, one database 102a may hold a list of check and automated clearing house (ACH) transactions with descriptive data about each transaction, such as the drawee routing and account numbers, the amount of the transaction, the date of the transaction, deposit account information, and status information. Another database 102b may include personal identifying information (PII) about a number of account owners. Another database 102c may hold information about the balances in accounts affected by the transaction information. Another database 102d may hold negative information contributed by one or more financial institutions about various account holders or former account holders. For example, database 102d may include a list of persons who hold or have held accounts previously suspected of being used for illicit activity, persons from whom a certain financial institutions have severed business relations, persons who have owned accounts that were closed for cause, and the like.

Preferably, the information in databases 102 is gathered from a number of financial institutions. That is, databases 102 preferably contain records of financial transactions occurring at and between a number of banks or other institutions, and may contain account ownership records for a number of accounts at a number of banks or other institutions.

Computer system 101 may be supplied with a list of one or more entities or transactions to investigate 103 and may produce one or more reports 104, as is described in more detail below.

In addition, computer system may 101 have access to a number of other data sources 105 from which other information may be retrieved, for example through the Internet 106. For example, data source 105a may contain news records of instances of financial crimes. Data source 105b may contain arrest records at the county or another level. Data source 105c may include the so-called “dark web”, and may contain evidence of the sale or manipulation of government-issued identification numbers such as social security numbers and the like. In any event, data sources 105 may be publicly (if not necessarily easily) accessible. Computer system 101 may “scrape” data sources 105 for information relevant to the techniques disclosed herein.

Computer system 101 may also be provided with one or more transaction rules 107, described in more detail below.

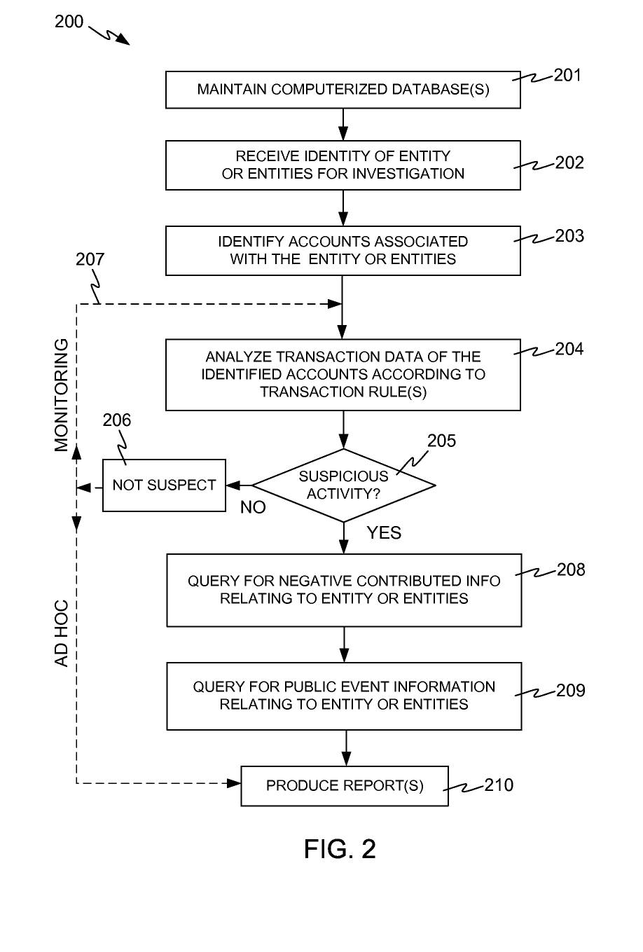

FIG. 2 illustrates a flowchart of a method 200 in accordance with embodiments of the invention. In step 201, one or more databases such as databases 102 are maintained.

In step 202, an indication is received of the identity or identities of one or more entities for investigation. For example, a financial institution such as a bank may provide some identifying information about a particular entity. The identifying information could include one or more items such as a person's name, an official identifier such as a U.S. social security number, a tax identification number, or the like. An entity to be investigated may be a natural person, a company, an association, or another kind of entity. In some cases, an entity to be investigated may be an account owner or a potential account owner at the financial institution providing the identifying information. Identifying information may be received for a single entity to be investigated, or identifying information may be received for more than one entity to be investigated in a batch.

In other embodiments, the identity of an entity for investigation may be provided in the form of an account number or other identifier of a particular account. In this case, the owner of the account may be identified from the account ownership records in databases 102, and the owner is the entity for investigation.

In step 203, accounts associated with the entity or entities to be investigated are identified. For example, computer system may search account ownership records on one of databases 102 to identify accounts owned by an entity being investigated. Preferably, the account ownership records include records from multiple financial institutions, so that accounts owned by the entity can be identified at more than one financial institution.

In step 204, data about transactions involving the identified accounts is analyzed according to one or more transaction rules. For example, databases 102 may include records of check transactions affecting the identified accounts, wire transfer transactions, other deposit and withdrawal information, and other kinds of information. The transaction information may include the dates of transactions, amounts of transactions, the numbers of accounts on which funds were drawn to make deposits into the identified accounts, and other information.

The transaction rules define particular analyses used to determine whether suspicious activity has occurred. For example, the rules may consider the amounts of transactions affecting an identified account, the frequency of transactions, the source of deposited funds, the timing of withdrawals from the identified account, or other information. When the transaction information satisfies a particular rule, a determination is made that suspicious activity has occurred.

Many different transaction rules are possible. In a simple example, a transaction rule may specify that if a particular account received a series of cash deposits over a period days in which each of the deposits is slightly under an amount that would trigger cash transaction reporting requirements, and then a large withdrawal was made from the account shortly thereafter, then the activity is deemed suspicious. In another example, activity may be deemed suspicious if an account receives, over a period of days, a number of deposits in integer dollar amounts drawn on accounts owned by money service businesses. Additional specific examples of transaction rules are described in more detail below.

In some embodiments, transaction records of multiple financial institutions may be considered, so that suspicious activity spanning several institutions can be detected, even though the activity an any one of the institutions may appear to be innocuous. The transaction rules may be designed to uncover suspicious patterns in transactions that, taken individually, may appear to be legitimate.

In some embodiments, particular transaction rules may be supplied by the financial institution requesting investigation of a particular entity, as part of the request. For example, the requesting institution may be interested in a particular kind of activity. In other embodiments, “stock” transaction rules may be used. Custom and stock transaction rules may be used in conjunction.

Referring again to FIG. 2, in step 205, the results of the analysis are checked to see if the analysis determined that suspicious activity has occurred. If not, then the entity being investigated may be considered as not suspect in step 206, at least for the time being. Optionally, if ongoing monitoring is being performed, the analysis may be repeated on an ongoing basis, as indicated by flow 207.

In some cases, the analysis will result in a determination that suspicious activity has occurred. In this case, additional information is obtained that may be pertinent to the evaluation of a particular entity as suspect or not.

In step 208, a query is made for negative contributed information about the entity being investigated. As is described above, negative contributed information is information contributed by one or more financial institutions reflecting negative history with respect to particular individuals or other entities. For example, a particular entity may have had an account closed for cause at a particular financial institution, and the financial institution may contribute a record of the account closure to the system. The negative contributed information may have been collected in one of databases 102, which may be simply queried as needed in step 208, or participating financial institutions may polled for negative information whenever step 208 is reached, or a combination of these approaches may be used.

In step 209, a query is made for public event information relating to the entity or entities being investigated. Public event information is any publicly available information relating to the entity being investigated, for example from data sources 105. The public event information may have been collected into one of databases 102 which may simply be queried in step 209, or information sources 105 may be scraped as needed in step 209, or a combination of these approaches may be used. Public event information may include such information as a news report or public record of a conviction of a person for committing a financial crime, evidence gathered from the dark web that the person has been involved in the illicit trade of stolen identity information, a public record of a prior foreclosure involving an entity being investigated, or other kinds of public events. Many kinds of public event information are possible.

In step 210, a report is produced of the results of the investigation of each entity. Each report may include, for example, the fact that the one or more transaction rules deemed certain account activity involving the entity to be suspicious. In some embodiments, the report may include negative contributed information obtained as a result of the query of step 208. In some embodiments, the report may include public event information obtained as a result of the query of step 209. The possible inclusion of negative contributed information and public event information in the report may present a more complete picture of the activities of a particular entity than can be drawn by analysis of transaction information alone.

In some embodiments, investigations of particular entities may be performed on an ad hoc basis. That is, a requester may identify one or more entities for one-time investigation, and one or more reports may be produced as a result. The request may include only a single entity identifier, or multiple entity identifiers to be investigated in a batch, but in the ad hoc analysis no ongoing monitoring may be done.

By contrast, in other embodiments, ongoing monitoring may be performed for the investigation of a single entity or multiple entities. For example, the requester may supply one or more entity identifiers and request that accounts relating to the entities be monitored on an ongoing basis. Ongoing monitoring may involve performing an analysis similar to the ad hoc analysis multiple times, for example daily, weekly, monthly, or on another schedule. In other embodiments, the ongoing analysis may differ from the ad hoc analysis.

Example transaction rule—international correspondent items

A wide variety of transaction rules may be used in embodiments of the invention, and individual transaction rules may be designed to detect specific kinds of suspicious activity. For example, in some money laundering schemes, international money transfers may be used to conceal the source of funds or to at least make the source more difficult to discern.

In some embodiments, computer 101 is specially programmed to use information from databases 102 to identify deposits into accounts associated with the entity being investigated, and to further identify deposits made with checks drawn on U.S. subsidiaries of international financial institutions such as banks For example, computer system 101 may be specially programmed to implement the techniques described in more detail below. A check drawn on a U.S. subsidiary of an international financial institution may be termed a “correspondent” item, and in particular an “international correspondent item”. A correspondent bank is one that conducts transactions on behalf of another institution. Correspondent relationships often exist between banks in different countries, but may also exist between institutions within a country. The use of correspondent banks may signal an international transfer, and coupled with other banking patterns may raise a suspicion of money laundering. For example, an unusual number of deposits made using international correspondent items into and entity's accounts may raise a suspicion of money laundering.

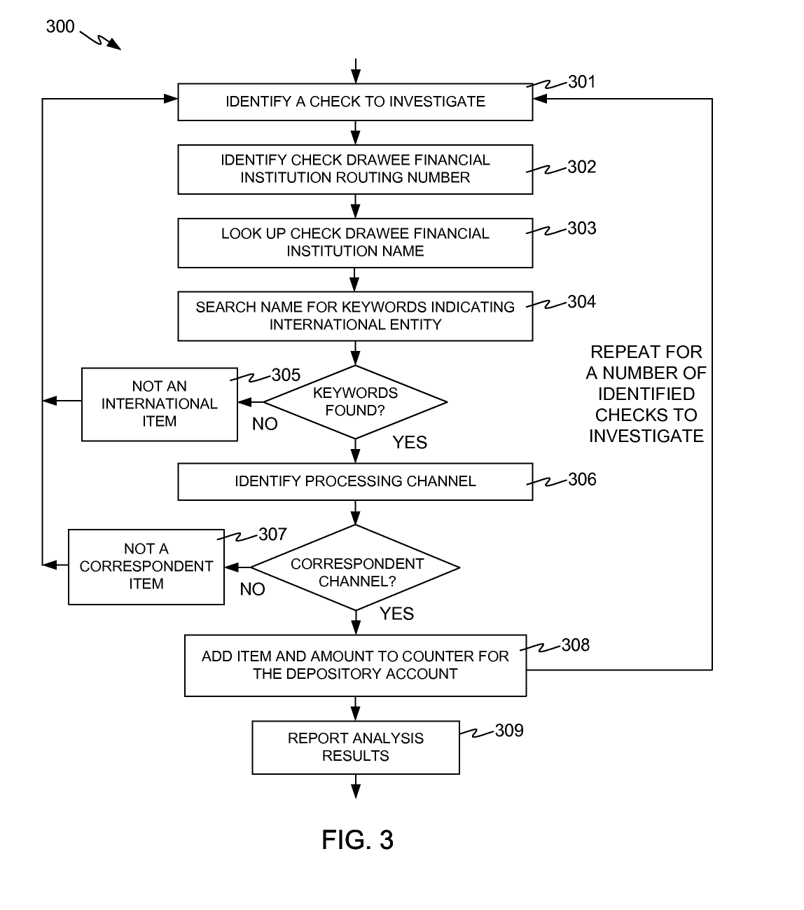

FIG. 3 illustrates a flow chart of a method 300 in accordance with embodiments of the invention, including steps that may be performed by computer system 101 in analyzing transaction information according to transaction a rule. That is, method 300 may be performed as part of step 204 in FIG. 2.

Because no individual item of information in databases 102 may explicitly identify a check as having been drawn on a U.S. subsidiary of an international bank, information from a number of sources may be combined to deduce the status of a particular check.

In step 301, a check of interest is identified for investigation. For example, the transaction information in databases 102 includes detailed information about transactions involving the accounts that have been identified as being associated with an entity being investigated. The detailed information may include records of deposits made by check, and the checks used to make the deposits may be the checks of interest. Preferably, computer system 101 automatically locates from databases 102 check information associated with the accounts identified in step 203 of method 200.

In step 302, the bank identification number (BIN) of the institution on which the check is drawn is identified. For example, this may be accomplished by parsing the transaction information for the check in one of databases 102.

In step 303, the name of the drawee financial institution is determined from the BIN. In some embodiments, the institution name may be determined using a straightforward table lookup in one of databases 102. For example, one of databases 102 may contain the Thomson Bank Directory or a similar listing that correlates BINs with the names of their associated banks

Once the name of the drawee bank is known, it may be “text mined” to assess whether the name suggests that the drawee financial institution is an international bank, using a keyword search as is shown in step 304 or another method. For example, the bank name may include one or more words like “international” or “global”, or may contain the name of a foreign country, for example “Bank of Canada”. Other keywords or phrases may be used as well. In some embodiments, an institution name containing one or more such words or phrases may be taken to be the name of an international bank. An institution name lacking any such words or phrases may be taken to be the name of a domestic institution.

In step 305, if no suggestion of an international transaction was found in the drawee institution name, it may be presumed that the check being analyzed was not drawn on a U.S. subsidiary of an international bank, at least because the drawee institution does not appear to be international.

When the drawee name indicates an international item, then the check can be further analyzed to ascertain whether it was also drawn on a U.S. subsidiary of an international bank.

Another of databases 102 may contain additional information about each of the check-based financial transactions, for example information indicating how the check was processed or received. One particular code may indicate that a check was processed as a correspondent item.

In step 306, the processing channel code is checked to see if it indicates a correspondent item. If not, it may be presumed in step 307 that the check is not a correspondent item, and therefore also not an international correspondent item. However, when the channel code indicating a correspondent item is found for a particular check that has already been deemed to have been drawn on an international bank, there is a strong presumption that the check was drawn on a U.S. subsidiary of the international bank because the check is both 1) drawn on an international institution and 2) a correspondent item.

As multiple checks are processed, a tally is kept in step 308 for each analyzed account that has received checks drawn on U.S. subsidiaries of international financial institutions (international correspondent items). The tally may include the number of such checks deposited into each respective account, aggregate amounts of such checks, or both. Other information could be tracked as well, for example the sizes of the deposits, the frequency of the deposits, and or other information.

A number of checks may be investigated in this manner, with the account-specific tallies accumulating the numbers and amounts of the identified deposits, and possibly other information.

In step 309, the results of the analysis are reported. For the purposes of this disclosure, “reporting” encompasses producing a written or electronic report, and also encompasses making the results are made available for further use in steps of method 200, for example by being stored in an accessible memory location in computer system 101, or by other methods. The report may include various kinds of information, including any one, any combination, or all of a) the number of international correspondent items deposited into each account over a period of time, b) the total monetary amount of international correspondent items deposited into each account, c) the number of accounts owned by a particular entity and having received deposits of international correspondent items, and d) the total monetary amount of deposits of international correspondent items received into an account or accounts owned by a particular entity. Each of these items may also be indicated as a rate. For example, the total monetary amount of international correspondent items deposited into a particular account may be reported as the total amount deposited over a period of time. Other information may be included as well.

Because the checks analyzed in method 300 were previously identified as involving accounts associated with a particular entity being investigated, the tallies are a representation of the international correspondent deposit activity of the entity, to the extent determinable from databases 102.

And because databases 102 preferably include transaction and other data from multiple financial institutions, the tallies can help detect money laundering even if the deposits were spread among financial institutions in an effort to conceal them from scrutiny. For example, the analysis may detect that person A owns an account at financial institution #1 that has received seven international correspondent item deposits totaling $8,000 during the past 14 days, and that person A also owns an account at financial institution #2 that has received nine international correspondent item deposits totaling $14,000 during the past 14 days. This analysis may be referred to as a “cross-bank” or “cross-financial institution” analysis, because it can detect activities by a single person at a number of institutions.

Referring again to FIG. 2, the information reported from method 300 may be used in step 205, in the determination of whether suspicious activity has been detected with respect to the entity being investigated. For example, it may be determined that the entity being investigated owns or is associated with accounts with unusually high receipts or rates of receipt of international correspondent item deposits, and therefore that suspicious activity has been detected.

Example transaction rule—cash equivalent structuring and funnel account behavior

In some money laundering schemes, money service businesses may be employed in an attempt to conceal the source of funds. A money service business (MSB) is defined by the U.S. Treasury Department as a person (other than a bank or an entity regulated by the Securities and Exchange Commission or the Commodity Futures Trading Commission) doing business as a currency dealer or exchanger, a check casher, an issuer of traveler's checks, money orders, or stored value, a seller or redeemer of traveler's checks, money orders, or stored value, a money transmitter, or the U.S. Postal Service. For example, a person wishing to mask the source of funds may provide cash to a money transmitter and then employ the services of the money transmitter to transfer the funds to an account. The resulting account deposit will thus be recorded as having been drawn on the account of the legitimate money transmitter, concealing or at least obfuscating the source from which the money transmitter received the funds. From the point of view of the depository account, funds drawn on an account owned by a money service business may be considered “cash equivalent” funds, because they arrive at the depository account without any indication of their source prior to the transfer by the money service business.

Some embodiments of the invention consider patterns in the use of money service businesses in the analysis of whether suspicious activity has occurred. Embodiments of the invention may also consider patterns in the amounts and timing of deposits and withdrawals to specific accounts.

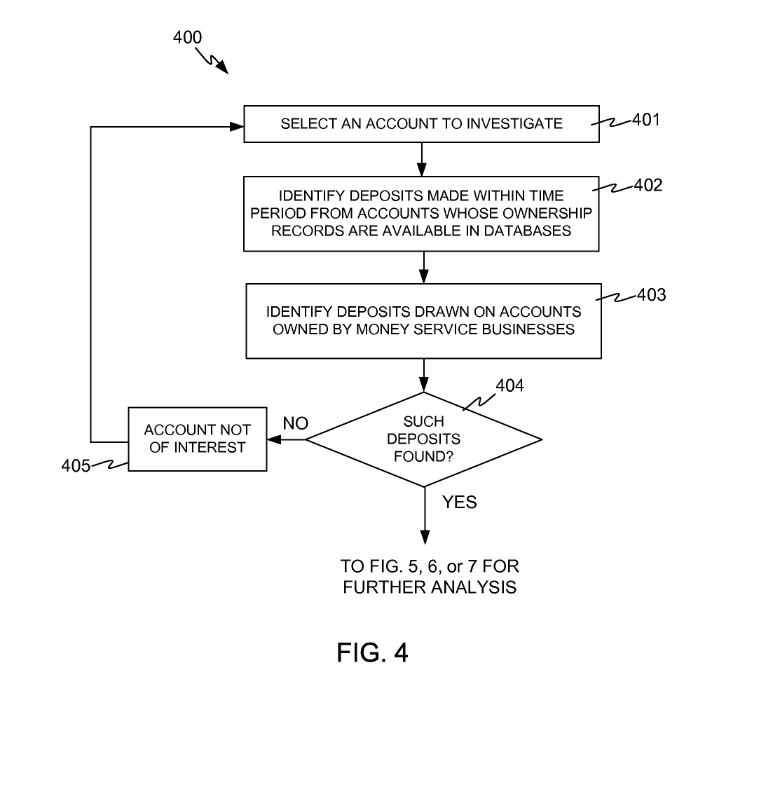

FIG. 4 illustrates a flow chart of a method 400 in accordance with embodiments of the invention for identifying records of an account for further investigation, including steps that may be performed by computer system 101 in analyzing transaction information according to transaction a rule. That is, method 400 may be performed as part of step 204 in FIG. 2.

In step 401, an account of interest is selected for investigation from the accounts identified in step 203 of FIG. 2.

In step 402, databases 102 are searched for records of deposits made into the account selected in step 401, for which drawee account ownership records are available in databases 102, and which were made within a predetermined time period. For example, deposits made into the account within the past 14 days (or another suitable time period) may be investigated. For this purpose, a database having deposit records including drawee account numbers and other information may be accessed.

In step 403, deposits identified in step 402 are further filtered to identify deposits that were drawn on accounts identifiable as being owned by money service businesses. For example, a database having a table of accounts owned or otherwise associated with money service businesses and correlating the account numbers with the owners of the accounts may be accessed. If no such deposits are found as shown in step 404, then the account being investigated is not of interest for the techniques of this disclosure, as shown in step 405, and another account may be selected for investigation if not all accounts have been investigated. (The account could still be of interest for other purposes.) If such deposits are found, then further analysis is performed.

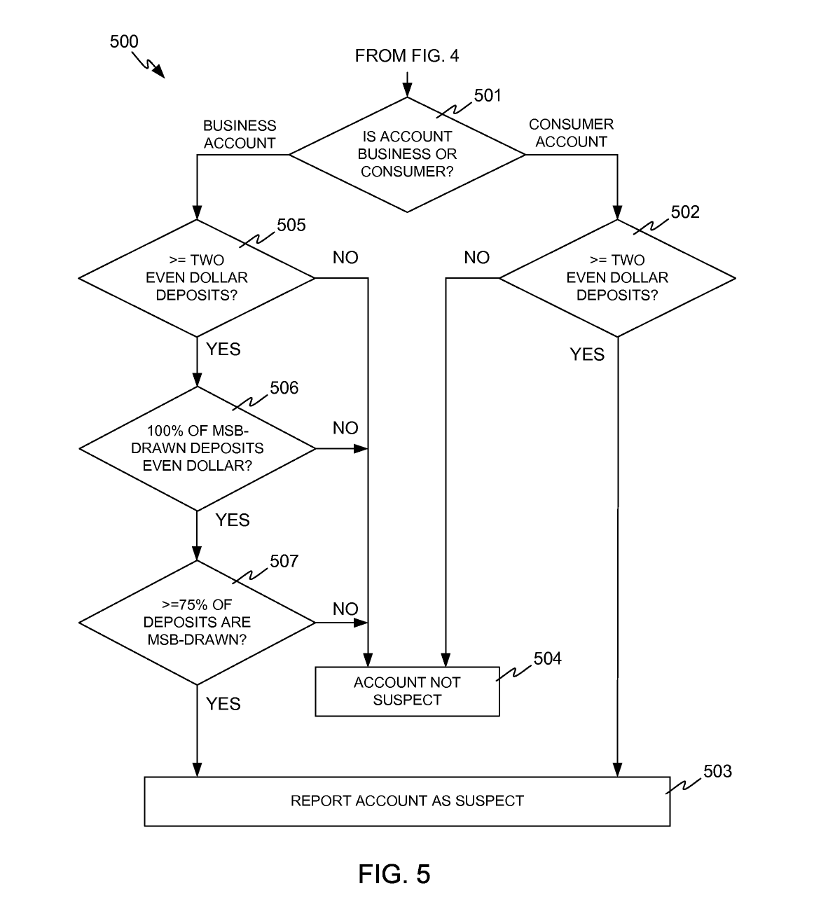

FIG. 5 illustrates a flow chart of a method 500 in accordance with embodiments of the invention, for analysis of deposits identified in method 400 as having been made within the predetermined time period and drawn from accounts owned by money service businesses. In the example method of FIG. 5, the number and amounts of deposits are analyzed to identify accounts suspected of being used for money laundering.

In some embodiments, business accounts and consumer accounts may be analyzed using different criteria for deciding whether account activity is suspicious or not. For example, in step 501, it is determined whether the particular account being investigated is a business account or a consumer account. For a consumer account, deposit records for the account are analyzed in step 502 to determine if there have been at least two deposits received (within the time period of interest from accounts owned by money service businesses) that are in even (integer) dollar amounts, for example $700.00, $1501.00, $2322.00, or the like. Examples of amounts that are not even dollar amounts are $2376.25, $1087.92 and the like. In the example of FIG. 5, if there have been at least two even-dollar deposits into an account within the time period of interest drawn on accounts owned by money service businesses, then that account is flagged at step 503 as being suspect and this fact is reported. If not, then the account is not considered suspect, as shown at step 504. It will be recognized that the threshold of two for the number of identified deposits is but an example, and other thresholds may be used in other embodiments.

For an account that is identified as a business account, different or additional criteria may be applied. For example, in step 505, a test similar to step 502 may be applied, to determine whether the business account being investigated has received at least two even-dollar deposits within the time period of interest drawn on accounts owned by money service businesses. If not, the account is not considered as suspect, as shown in step 504.

However if so, then the account is further analyzed in step 506 to determine whether 100% of deposits received during the time period of interest from accounts owned by money service businesses were in even dollar amounts. In some embodiments, a threshold lower than 100% may be used. If not, the account is not considered as suspect, as shown in step 504.

However if so, then the account is still further analyzed in step 507 to determine whether at least 75% (or another suitable portion) of the deposits to the account are drawn on accounts owned by money service businesses. If not, the account is not considered as suspect, as shown in step 504. However if so, then the account is flagged at step 503 as being suspect and this fact is reported.

Referring again to FIG. 2, the information reported from method 500 may inform the decision performed at step 205.

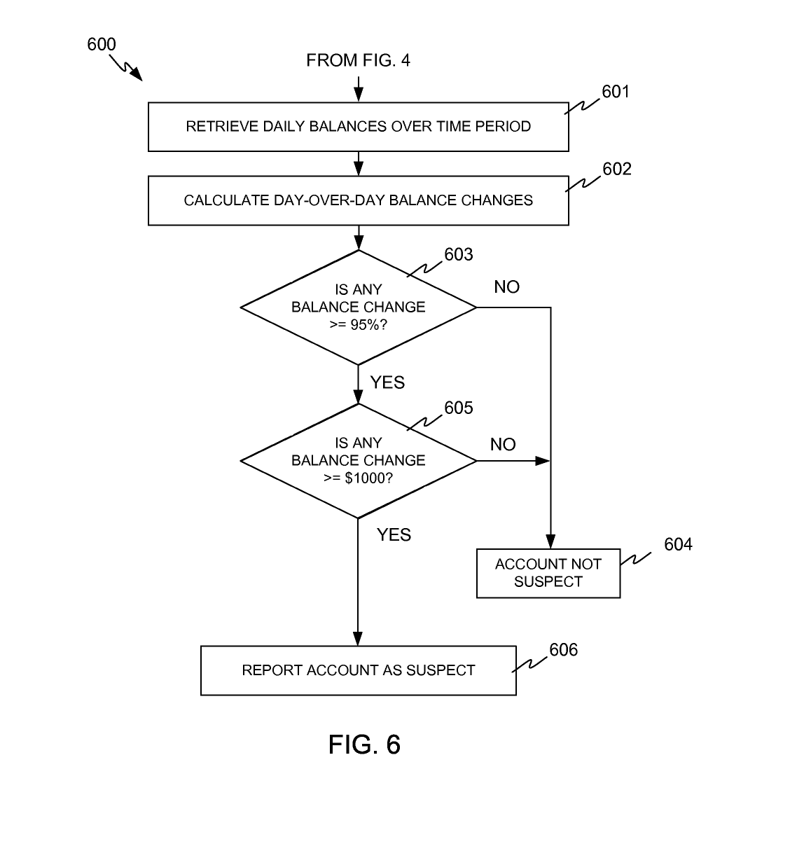

FIG. 6 illustrates a flow chart of a method 600 in accordance with other embodiments of the invention, for analysis of deposits identified in method 400 as having been made within the predetermined time period and drawn from accounts owned by money service businesses. In the example method of FIG. 6, the timing and amounts of deposits and withdrawals are analyzed to identify accounts suspected of being used as funnel accounts for money laundering.

For example, in step 601, the daily balances over the time period of interest in the account being investigated are retrieved from databases 102.

In step 602, the percentage day-over-day change in the balance of the account is computed for each day interval in the time period of interest. In some embodiments, the percentage change in an account balance may be computed as

$$Balance \% change = \frac{\vert Balance Day 2 - Balance Day 1 \vert}{( Balance Day 1 )} \times 100$$

For example, if a particular account has a balance or $5000.00 on Day 1 and a balance of $1.00 on Day 2, the percentage change in the balance between Day 1 and Day 2 is 99.98%. In addition, the change in the principal balance is a $4999.00 reduction.

In step 603, the daily balance changes are investigated to see if any of them results in a change of 95% or more in the account balance. It will be recognized that the threshold of 95% is an example, and that other thresholds may be used. If no balance change of at least 95% is found, the account is not considered as suspect, as shown in step 604.

However if such a balance change is detected, the daily balance changes are further investigated in step 605 to determine if the balance in the account has changed by more than $1000.00 (or another suitable threshold amount) between any two days in the time period of interest. If not, the account is not considered as suspect, as shown in step 604.

However if so, the account is flagged at step 606 as being suspect and this fact is reported. The embodiment of FIG. 6 may be especially useful in detecting the gradual buildup of an account balance by a series of small deposits drawn on money services businesses, and then the abrupt withdrawal of all or nearly all of the balance of the account. Such a pattern of gradual deposits and sudden withdrawals may be a suspected precursor of especially trade based money laundering.

Referring again to FIG. 2, the information reported from method 600 may inform the decision performed at step 205.

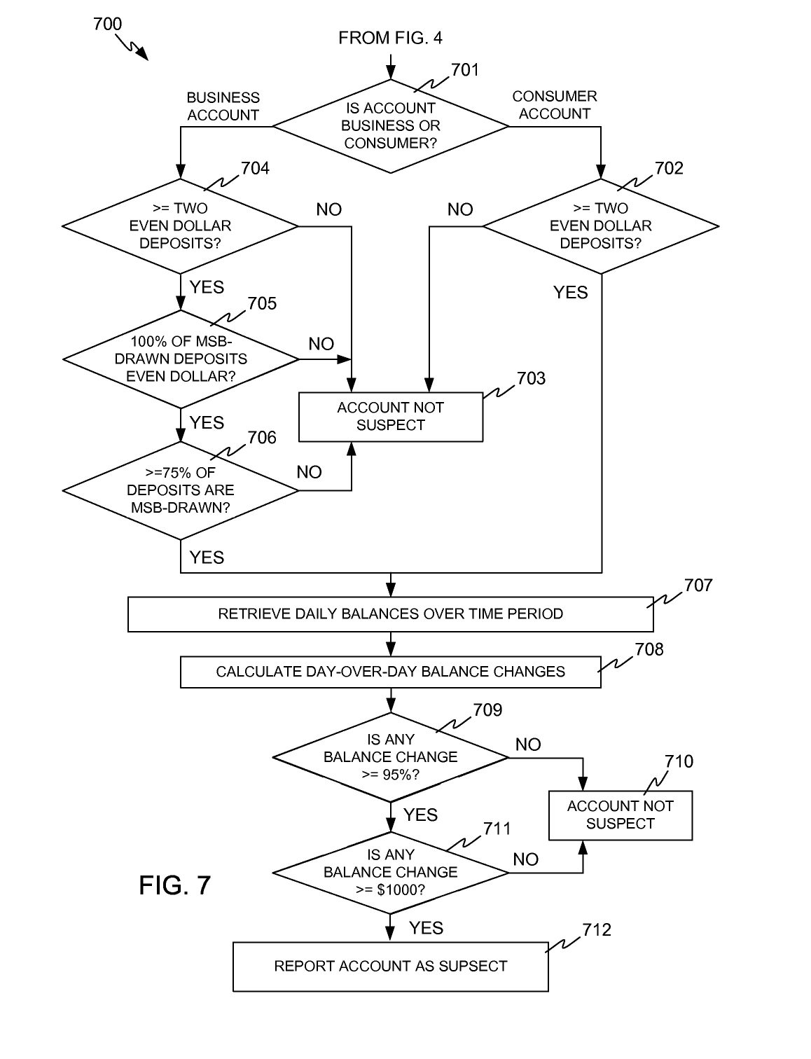

FIG. 7 illustrates a flow chart of a method 700 in accordance with other embodiments of the invention, for analysis of deposits identified in method 400 as having been made within the predetermined time period and drawn from accounts owned by money service businesses. Example method 700 combines methods 500 and 600 in series. Steps 701-706 correspond to steps 501, 502, and 504-507 shown in FIG. 5, and steps 707-712 correspond to steps 601-606 shown in FIG. 6. In the embodiment of FIG. 7, a consumer account is not categorized as suspect unless all of tests 702, 709, and 711 result in an answer of “YES”, and a business account is not categorized as suspect unless all of tests 704, 705, 706, 709, and 711 result in an answer of “YES”. Accordingly, an account classified as suspect using method 700 may carry an especially strong suspicion of being used for illicit activity.

In other embodiments, fewer than all of the steps of method 500, 600, or 700 may be performed, and in other embodiments, steps may be performed in a different order than is illustrated. The steps of methods such as methods 500, 600, or 700 may be repeated for a number of different accounts.

Referring again to FIG. 2, the information reported from method 700 may inform the decision performed at step 205.

Transaction Data Monitoring

In the embodiments described above, particular entities are investigated, for example entities identified by a financial institution for investigation. Once an entity is selected for investigation, accounts associated with that entity are identified and transaction activity within those accounts is analyzed, using transaction rules, to see if any suspicious activity may be evident.

In other embodiments, transaction rules may be applied to transaction data to identify entities exhibiting suspicious activity. That is, while the above techniques start with one or more designated entities to investigate and then delve into transaction data, other embodiments start with transaction data and analyze it with the intention of identifying suspect entities.

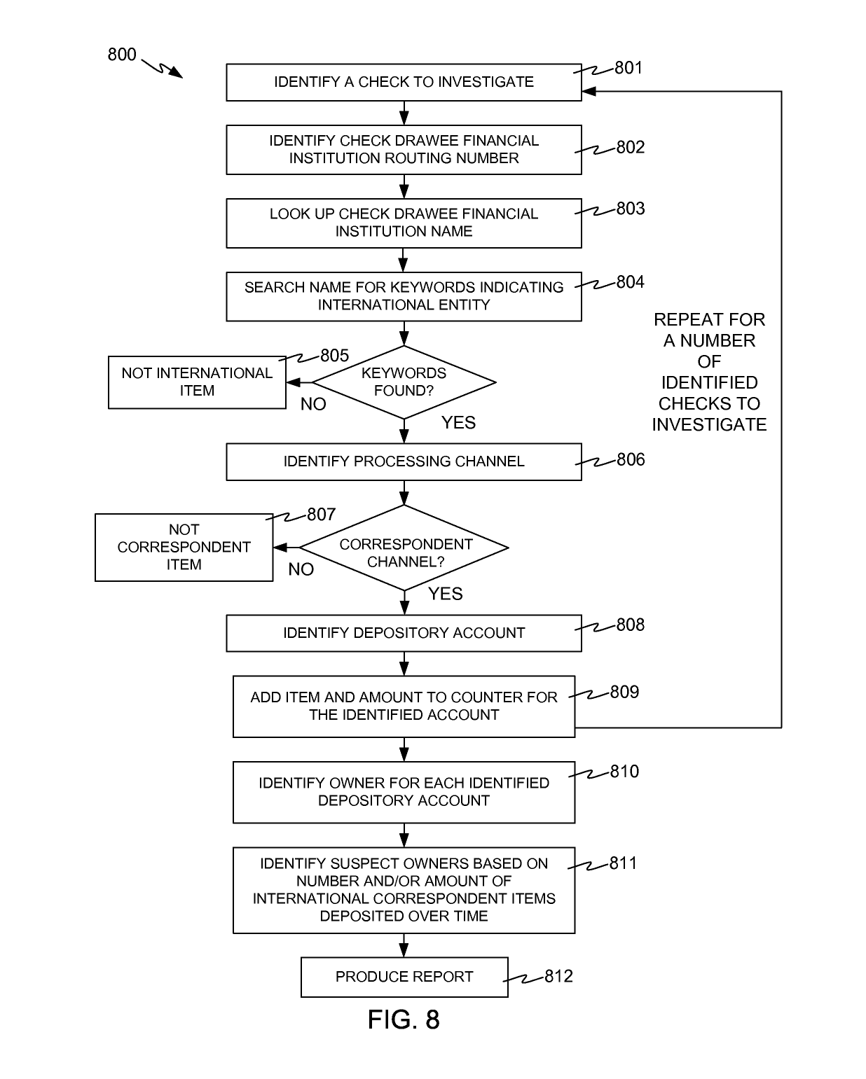

FIG. 8 illustrates a flow chart of a method 800 for analyzing transaction data to identify one or more suspect entities, in accordance with embodiments of the invention. In example method 800, the use of international correspondent items is investigated with the intention of uncovering suspicious activity on the part of one or more entities. Method 800 may be performed by computer system 101.

Because no individual item of information in databases 102 may explicitly identify a check as having been drawn on a U.S. subsidiary of an international bank, information from a number of sources may be combined to deduce the status of a particular check.

In step 801, a check of interest is identified for investigation. For example, a particular financial institution may supply a list of checks to be investigated and a particular check to be investigated may be selected from the list, or a check to be investigated may be identified in some other way.

In step 802, the bank identification number (BIN) of the institution on which the check is drawn is identified. For example, this may be accomplished by parsing the transaction information for the check in one of databases 102.

In step 803, the name of the drawee financial institution is determined from the BIN. In some embodiments, the institution name may be determined using a straightforward table lookup in one of databases 102. For example, one of databases 102 may contain the Thomson Bank Directory or a similar listing that correlates BINs with the names of their associated banks

Once the name of the drawee bank is known, it may be “text mined” to assess whether the name suggests that the drawee financial institution is an international bank, using a keyword search as is shown in step 804 or another method. For example, the bank name may include one or more words like “international” or “global”, or may contain the name of a foreign country, for example “Bank of Canada”. Other keywords or phrases may be used as well. In some embodiments, an institution name containing one or more such words or phrases may be taken to be the name of an international bank. An institution name lacking any such words or phrases may be taken to be the name of a domestic institution.

In step 805, if no suggestion of an international transaction was found in the drawee institution name, it may be presumed that the check being analyzed was not drawn on a U.S. subsidiary of an international bank, at least because the drawee institution does not appear to be international.

When the drawee name indicates an international item, then the check can be further analyzed to ascertain whether it was also drawn on a U.S. subsidiary of an international bank.

Another of databases 102 may contain additional information about each of the check-based financial transactions, for example information indicating how the check was processed or received. One particular code may indicate that a check was processed as a correspondent item.

In step 806, the processing channel code is checked to see if it indicates a correspondent item. If not, it may be presumed in step 807 that the check is not a correspondent item, and therefore also not an international correspondent item. However, when the channel code indicating a correspondent item is found for a particular check that has already been deemed to have been drawn on an international bank, there is a strong presumption that the check was drawn on a U.S. subsidiary of the international bank because the check is both 1) drawn on an international institution and 2) a correspondent item.

Once a check is identified as an international correspondent item, the account to which the check was deposited is identified in step 808. For this purpose, one or more of databases 102 may contain account records from a number of financial institutions. The “depository account” to which the check was deposited is identified in the check transaction information in databases 102.

As multiple checks are processed, a tally is kept in step 809 for each depository account that has received checks drawn on U.S. subsidiaries of international financial institutions (international correspondent items). The tally may include the number of such checks deposited into each respective account, aggregate amounts of such checks, or both. Other information could be tracked as well, for example the sizes of the deposits, the frequency of the deposits, and or other information.

A number of checks may be investigated in this manner, with the account-specific tallies accumulating the numbers and amounts of the identified deposits, and possibly other information.

In step 810, the owner of each of the identified accounts is ascertained. For example, the name of the owner of each depository account may be retrieved from account information supplied by various financial institutions and stored in one of databases 102.

The list of identified owners is further analyzed in step 811 to identify persons owning accounts that collectively receive unusual numbers of deposits by international correspondent items over a period of time, even if the deposits are spread among a number of different depository institutions. For example, the analysis may detect that person A owns an account at financial institution #1 that has received seven international correspondent item deposits totaling $8,000 during the past 14 days, and that person A also owns an account at financial institution #2 that has received nine international correspondent item deposits totaling $14,000 during the past 14 days. This analysis may be referred to as a “cross-bank” or “cross-financial institution” analysis, because it can detect activities by a single person at a number of institutions.

Thus, owners of accounts with unusually high receipts or rates of receipt of international correspondent item deposits may be identified.

In step 812, a report of the analysis is produced. The report may include various kinds of information, including any one, any combination, or all of a) the number international correspondent items deposited into a particular account over a period of time, b) the total monetary amount of international correspondent items deposited into a particular account, c) the number of accounts owned by a particular person and having received deposits of international correspondent items, and d) the total monetary amount of deposits of international correspondent items received into a particular account or accounts owned by a particular person individual. Each of these items may be repeated for other accounts and account owners, and any monetary amount may also be indicated as a rate. For example, the total monetary amount of international correspondent items deposited into a particular account may be reported as the total amount deposited over a period of time. Other information may be included as well.

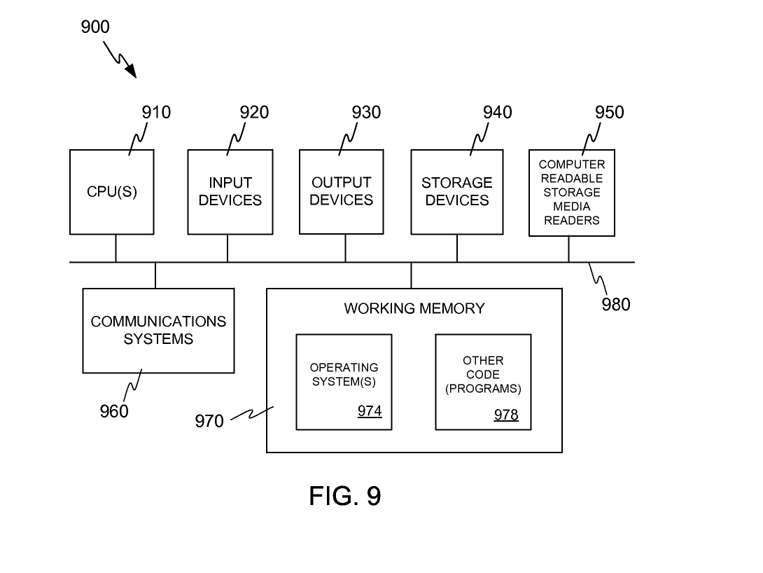

FIG. 9 is a block diagram illustrating an exemplary computer system 900 upon which embodiments of the present invention may be implemented. This example illustrates a computer system 900 such as may be used, in whole, in part, or with various modifications, to provide the functions of the system 100, as well as other components and functions of the invention described herein.

The computer system 900 is shown comprising hardware elements that may be electrically coupled via a bus 980. The hardware elements may include one or more central processing units 910, one or more input devices 920 (e.g., a mouse, a keyboard, etc.), and one or more output devices 930 (e.g., a display device, a printer, etc.). The computer system 900 may also include one or more storage devices 940, representing remote, local, fixed, and/or removable storage devices and storage media for temporarily and/or more permanently containing computer-readable information, and one or more storage media reader(s) 950 for accessing the storage device(s) 940. By way of example, storage device(s) 940 may be disk drives, optical storage devices, solid-state storage device such as a random access memory (“RAM”) and/or a read-only memory (“ROM”), which can be programmable, flash-updateable or the like.

The computer system 900 may additionally include a communications system 960 (e.g., a modem, a network card—wireless or wired, an infra-red communication device, a Bluetooth™ device, a near field communications (NFC) device, a cellular communication device, etc.) The communications system 960 may permit data to be exchanged with a network, system, computer, mobile device and/or other component as described earlier. The system 900 also includes working memory 970, which may include RAM and ROM devices as described above.

The computer system 900 may also comprise software elements, shown as being located within a working memory 970, including an operating system 974 and/or other code 978. Software code 978 may be used for implementing functions of various elements of the architecture as described herein. For example, software stored on and/or executed by a computer system, such as system 900, can be used in implementing the processes seen in FIGS. 2-8.

It should be appreciated that alternative embodiments of a computer system 900 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the system 100 system may be implemented by a single system having one or more storage device and processing elements.

Moreover, while the various flows and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for identifying suspicious account activity, the method, comprising:
maintaining one or more computerized databases holding records of financial transactions and other information, including information about financial transactions involving a number of accounts and ownership records of the number of accounts;
receiving an indication of the identity of a particular entity for investigation;
identifying, from the account ownership records, one or more accounts associated with the particular entity;
analyzing transaction records of the accounts associated with the particular entity according to one or more transaction rules to determine that suspicious activity has been detected with respect to one or more particular accounts;
querying for negative contributed information relating to the identified entity;
querying for public event information relating to the identified entity; and
producing a report naming the identified entity, the report including at least the fact of the detection of suspicious activity in the one or more particular accounts.

2. The method of claim 1, wherein the report further includes negative contributed information obtained as a result of the query for negative contributed information.

3. The method of claim 2, wherein the report further includes public event information obtained as a result of the query for public event information

4. The method of claim 1, wherein the report further includes public event information obtained as a result of the query for public event information.

5. The method of claim 1, further comprising receiving a specification of at least one of the one or more transaction rules from an entity from which a request for investigation of the particular entity is received.

6. The method of claim 1, wherein the indication of the identity of the particular entity for investigation is received in an ad hoc inquiry for investigation of the particular entity.

7. The method of claim 1, wherein:
the indication of the identity of the particular entity for investigation is received in a request for ongoing monitoring of account activity relating to the particular entity; and
analyzing transaction records of the accounts associated with the particular entity according to one or more transaction rules further comprises analyzing transaction records of the accounts associated with the particular entity according to one or more transaction rules on an ongoing basis.

8. The method of claim 1, wherein:
the indication of the identity of the particular entity for investigation is received in a request for investigation of the particular entity and a number of other entities; and
analyzing transaction records further comprises analyzing transaction records of the accounts associated with the other entities according to the one or more transaction rules.

9. The method of claim 1, wherein:
the records of financial transactions include records of financial transactions involving a number of accounts held at a number of financial institutions; and
analyzing transaction records of the accounts associated with the particular entity according to one or more transaction rules comprises analyzing transaction records of accounts held at multiple respective financial institutions and associated with the particular entity.

10. The method of claim 1, wherein at least one of the transaction rules detects deposits made into one or more accounts associated with the particular owner that are drawn on accounts owned by money service businesses and that are in even dollar amounts.

11. The method of claim 1, wherein at least one of the transaction rules detects deposits made into one or more accounts associated with the particular entity that are made using checks drawn on U.S. subsidiaries of international financial institutions.

12. The method of claim 1, wherein receiving an indication of the identity of a particular entity for investigation comprises:
receiving an identifier of a particular account; and
determining the owner of the particular account, the owner then being the entity for investigation.

13. A method, comprising:
maintaining one or more computerized databases holding records of check-based financial transactions and other information;
identifying from the one or more computerized databases a number of checks that have been drawn on U.S. subsidiaries of international financial institutions;
for each of the identified checks, identifying the owner of the account into which the check was deposited;
for each of a number of identified account owners, counting the number of the identified checks deposited into one or more accounts owned by the respective identified owner; and
producing a report of the respective number of identified checks deposited into one or more accounts owned by the respective identified owners.

14. The method of claim 13, wherein identifying a number of checks that have been drawn on U.S. subsidiaries of international financial institutions further comprises, for each of a number of checks being investigated:
identifying the check drawee financial institution from a routing number of a respective check;
looking up the name of the drawee financial institution in the one or more computerized databases;
searching the name of the drawee financial institution for text indicating that the drawee financial institution is an international financial institution; and
identifying the respective check as having been drawn on a U.S. subsidiary of an international financial institution based in part on the results of the keyword search.

15. The method of claim 14, wherein identifying a number of checks that have been drawn on U.S. subsidiaries of international financial institutions further comprises, for a check being investigated:
identifying a deposit channel of the respective check from data in the one or more computerized databases; and
identifying the respective check as having been drawn on a U.S. subsidiary of an international financial institution based in part on the deposit channel identification.

16. The method of claim 15, wherein a particular check is identified as having been drawn on a U.S. subsidiary of an international financial institution when:
a) the name of the drawee financial institution of the check contains one or more key words indicating that the drawee financial institution is an international financial institution; and
b) the deposit channel of the check is identified as a correspondent channel.

17. The method of claim 13, further comprising, for each of the number of identified account owners, counting the dollar amount of the identified checks deposited into one or more accounts owned by the respective identified owner.

18. The method of claim 13, further comprising, for each of the number of identified account owners, computing a rate of receipt of funds from the identified checks by the respective identified owner.

19. A method, comprising:
maintaining one or more computerized databases holding records of a number of deposits into a number of accounts at a number of financial institutions, the records indicating for each of the number of deposits at least the number of an account from which funds were drawn to make the deposit, the number of an account into which the deposit was made, the amount of the deposit, and the date of the deposit;
identifying, from the records, accounts that received deposits of funds drawn from accounts associated with one or more money service businesses within a predetermined time period; and
for each identified account:
evaluating whether the deposits received into the account drawn from accounts associated with one or more money service businesses were in even dollar amounts;
evaluating the number of deposits in even dollar amounts received into the account within the predetermined time period; and
categorizing the account as a suspected funnel account or not a suspected funnel account based at least in part on the evaluations;
wherein at least some of the identified accounts are categorized as suspected funnel accounts, and for at least each account categorized as a suspected funnel account, reporting the result of the categorization.

20. The method of claim 19, further comprising:
determining whether each account is a business account or a consumer account, including determining that at least one of the accounts is a business account and that at least one of the accounts is a consumer account; and
using a first set of criteria for categorizing business accounts, and using a second set of criteria, different from the first, for categorizing consumer accounts.

21. The method of claim 19, wherein categorizing a particular account as a suspected funnel account or not a suspected funnel account further comprises categorizing the account as a suspected funnel account when the number of deposits into the account in even dollar amounts drawn from accounts associated with one or more money services businesses within the predetermined time period is above a first threshold.

22. The method of claim 19, further comprising:
evaluating the magnitude of any withdrawals from the account within the predetermined time period; and
categorizing the account as a suspected funnel account or not a suspected funnel account based at least in part on the magnitude of the withdrawals.

23. The method of claim 22, wherein categorizing a particular account as a suspected funnel account or not a suspected funnel account further comprises categorizing the account as a suspected funnel account when:
the balance in the account has changed by more than a threshold percentage within the predetermined time period; and
the balance in the account has changed by more than a threshold amount between two consecutive days within the predetermined time period.

24. The method of claim 19, wherein categorizing a particular account as a suspected funnel account or not a suspected funnel account further comprises categorizing the account as a suspected funnel account when:
the number of deposits into the account in even dollar amounts drawn from accounts associated with one or more money services businesses within the predetermined time period is above a first threshold;
the percentage of deposits into the account drawn from accounts associated with one or more money services businesses within the predetermined time period that are in even dollar amounts meets or exceeds a second threshold; and
the percentage of deposits into the account that are drawn from accounts associated with one or more money services businesses is above a third threshold.
